(19) United States
(12) Patent Application Publication
(10) Pub. No.: US 2008/0086378 A1
(43) Pub. Date: Apr. 10, 2008

(54) ELECTRONIC CHECKOUT COUNTER SEPARATOR

(76) Inventor: Venkateshwara N. Reddy, Cupertino, CA (US)

Correspondence Address: HAHN AND MOODLEY, LLP, P.O. BOX 52050, MINNEAPOLIS, MN, 55402, US

(21) Appl. No.: 11/870,273

(22) Filed: Oct. 10, 2007

Related U.S. Application Data
(60) Provisional application No. 60/828,925, filed on Oct. 10, 2006.

(51) Int. Cl. G06Q 40/00

(52) U.S. Cl. 705/14

(57) ABSTRACT

Embodiments of the invention disclose an electronic checkout counter separator having a display and a communications interface whereby the separator receives advertisements for displaying on the display. An advertisement delivery system for delivering advertisement content to the electronic checkout counter separator is also disclosed.

This invention claims priority to U.S. Provisional patent Application No. 60/828,925 filed Oct. 10, 2006, the specification of which is hereby incorporated by reference.

### FIELD OF THE INVENTION

Embodiments of the invention relate to checkout counter separators.

### BACKGROUND

Stores that sell merchandise generally have one or more checkout counters located near an exit so that customers can check out merchandise or items by paying for the items at a checkout counter.

In some cases a checkout counter may have a counter top that includes a movable conveyor belt. The conveyor belt is operable by a cashier to move merchandise placed thereon by a customer towards the cashier so that the cashier can enter the items into a cash register and then bag the items.

As items of a first customer are moved or advanced towards the cashier through operation of the conveyor belt, new items may be placed on the conveyor belt. Eventually these new items make their way to the cashier through operation of the conveyor belt. The new items can be items of the first customer or items of a second customer.

In order to separate items of the first customer from items of the second customer, a checkout counter separator is usually placed on the conveyor belt between the items of the first and the second customer.

### SUMMARY OF THE INVENTION

According to one aspect of the invention, there is provided a method comprising receiving input defining an advertisement campaign from at least one advertiser, the advertisement campaign specifying advertisement content to be delivered to at least one checkout counter separator at a point of sales and delivering the advertisement content to the at least one checkout counter separator for display on a display thereof. The advertisement content may be delivered over a wireless network.

The method may include scheduling the advertisement content prior to delivering it to the at least one checkout counter separator. The method may include resolving schedule conflicts prior to delivering the advertisement content to the at least one checkout counter separator.

In addition, the method may include receiving payment for the scheduled advertisement content from the at least one advertiser.

The method may include delivering the advertisement content to a plurality of checkout counters in parallel.

According to another aspect of the invention, there is provided a checkout counter separator comprising an elongate body defining a longitudinal axis and at least two longitudinal sides, a data interface to receive advertisement content from an advertisement delivery system, and at least one electronic advertisement display panel defining a display face on at least one of the longitudinal sides, the display to display the advertisement content.

In one embodiment, the body may have three longitudinal sides so that the body is triangular in cross-section. In another embodiment, the body may have four longitudinal sides so that the body has a rectangular cross-section.

The data interface may be a wireless data interface. For example, the data interface may be an optical interface a Wi-Fi interface, a Bluetooth interface, a Mobile telephone network interface, or the like.

The electronic advertisement display may be in the form of a light emitting diode (LED) array, a liquid crystal display, an electroluminescent display, an electrophoretic display, interferometric modulators (imods), or the like.

The checkout counter separator may include an orientation sensor to detect the orientation of the elongate body on a support surface and to display the advertisement content in an upright orientation on the display. The orientation sensor may for example be in the form of a set of mercury switches.

The checkout counter separator may include a shock absorption arrangement. In one embodiment the shock absorption arrangement may be in the form of shock absorption material provided external onto the elongate body of the counter separator. In another embodiment, the shock absorption arrangement may be in the form of damping material provided internal to the elongate body between the elongate body and internal components of the checkout counter separator.

The checkout counter separator may include an internal rechargeable power source. The checkout counter separator may include a recharge arrangement connectable to an external power source for recharging the rechargeable power source. In one embodiment, the recharge arrangement may be in the form of a set of electric contacts and in another embodiment the recharge arrangement may be in the form of an inductive interface or inductive coupling.

For charging the counter separator, in one embodiment, a charging rail may be provided alongside a conveyor belt of a checkout counter. The charging rail may comprise coils that can be used to inductively charge the counter separator via the inductive interface. Alternatively, the charging rail may comprise contacts that can be engaged with corresponding contacts of the counter separator thereby to charge the counter separator.

In one embodiment, one of the longitudinal sides of the body may define a base on which the body can rest on a surface. In this embodiment, the base does not have a display. The body may include a self-orientating mechanism to orientate the body so that it always comes to rest on the surface with the base on the surface. The self-orientating mechanism may comprise a weight mounted within the body that provides ballast to the body so that it tends to come to rest on its base.

The checkout counter separator may comprise a user interface such as a “print button” which, when activated, causes information to be transmitted to a receiver. For example, the receiver may be connected to a printer, for information to be printed on the printer. In one embodiment the printer may be located in close proximity to the checkout counter. The information printed may comprise, for example, a coupon that is related to a particular advertisement displayed on the electronic display. In one embodiment, the information that is printed may comprise information such as the contact details of a particular advertiser.

In another embodiment, the information may be transmitted to a remote receiver of a consumer such as a mobile telephone, or the like. In this embodiment the coupon may be in electronic format.

According to another aspect of the invention, there is provided an advertisement delivery system comprising a database to store advertisement content of at least one advertiser, and a data interface to deliver the advertisement content of the at least one advertiser to at least one checkout counter separator.

The advertisement delivery system may include a scheduler to schedule the advertisement content of the at least one advertiser to be displayed according to a time schedule on the at least one counter separator.

The data interface of the advertisement delivery system may be in the form of a mobile telephone network interface to receive the advertisement content via a mobile telephone network onto the at least one checkout counter separator.

The advertisement delivery system may include a network interface to permit an advertiser to store advertisement content on the database.

The advertisement delivery system may include a billing system to bill an advertiser for advertisement content to be displayed on the at least one checkout counter separator.

Other aspects of the invention will be apparent from the detailed description below.

### BRIEF DESCRIPTION OF THE DRAWINGS

FIG. 1 shows a counter separator in accordance with one embodiment of the invention:

FIG. 2 shows cross section through the counter separator of FIG. 1 taken at 2-2:

FIG. 3 shows a counter separator in accordance with another embodiment of the invention;

FIG. 4 shows cross section through the counter separator of FIG. 3 taken at 4-4;

FIG. 5 shows a diagrammatic representation of a checkout counter in accordance with one embodiment of the invention, in plan view;

FIG. 6 shows a block diagram of electronics in a counter separator in accordance with one embodiment of the invention;

FIG. 7 shows an embodiment of a counter separator that has external contacts for charging;

FIG. 8 shows a plan view of a charging rail in accordance with one embodiment of the invention;

FIG. 9 shows a cross section through the charging rail of FIG. 8, taken at 9-9;

FIG. 10 shows an embodiment of an advertisement delivery system implementing a method of distributing advertisement content;

FIG. 11 shows a flow diagram of a method of defining an advertisement campaign;

FIG. 12 shows a database of advertisement campaigns;

FIG. 13 shows a method of scheduling advertisement content;

FIG. 14 shows a database of checkout counter separators;

FIG. 15 shows a flow diagram of a method of distributing advertisement content to at least one checkout counter separator;

FIG. 16 shows a schematic block diagram of an embodiment of an advertisement delivery system; and

FIG. 17 shows a functional block diagram of the advertisement delivery system of FIG. 16.

### DETAILED DESCRIPTION

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in this specification to “one embodiment” or “an embodiment” means that a particular feature, structure, or characteristic described in connection with the embodiment is included in at least one embodiment of the invention. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

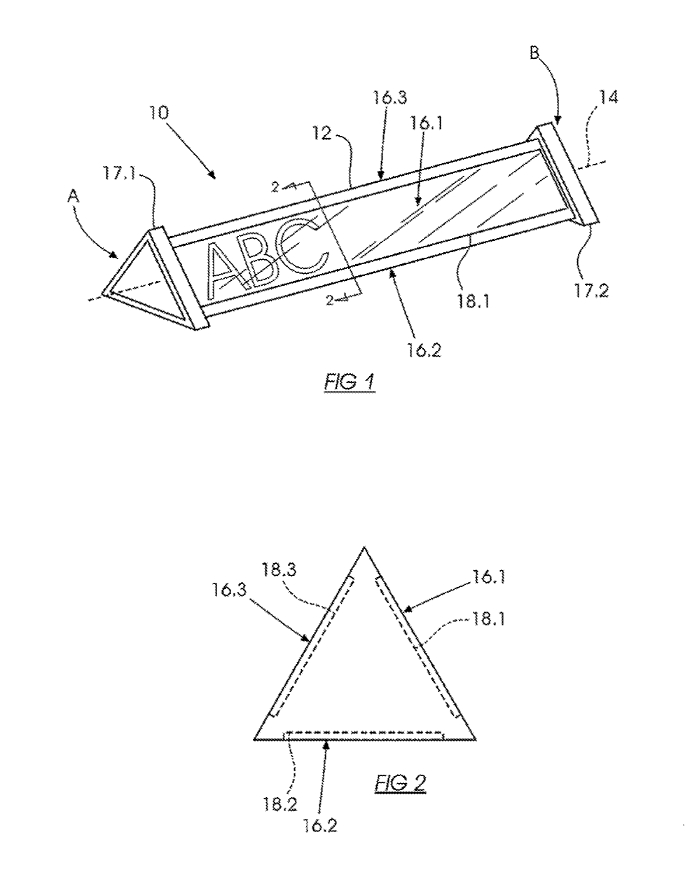

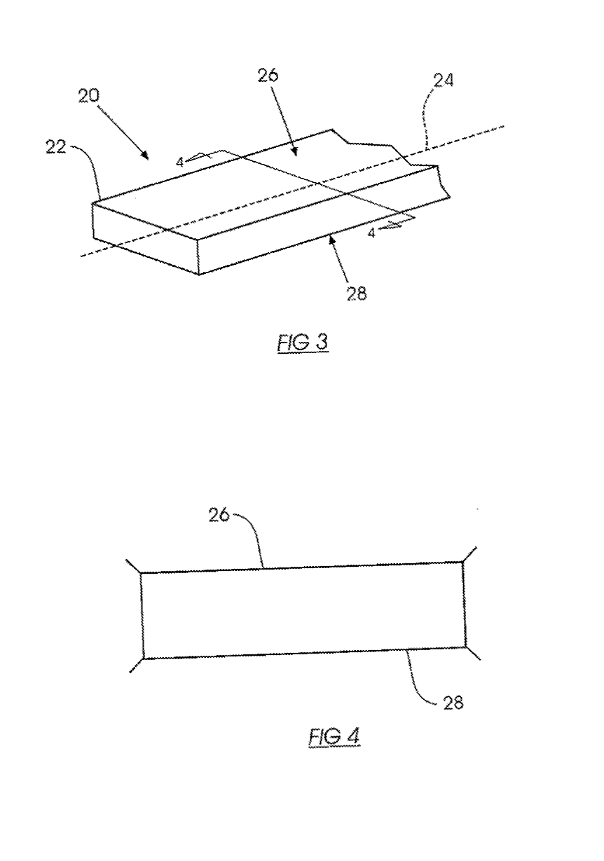

In FIG. 1 of the drawings, there is shown a checkout counter separator 10, in accordance with one embodiment of the invention. As will be seen, the counter separator 10 includes an elongate body 12. The body 12 has a longitudinal axis 14 and three longitudinal sides disposed around the longitudinal axis 14 so that the body 12 has a triangular cross section as will be seen from FIG. 2 which shows a cross-section through the body 12 taken at 2-2 in FIG. 1. The longitudinal sides define three display faces 16.1, 16.2, 16.3. In one embodiment, each of the three display faces 16.1, 16.2, 16.3 includes an electronic display 18.1, 18.2, 18.3

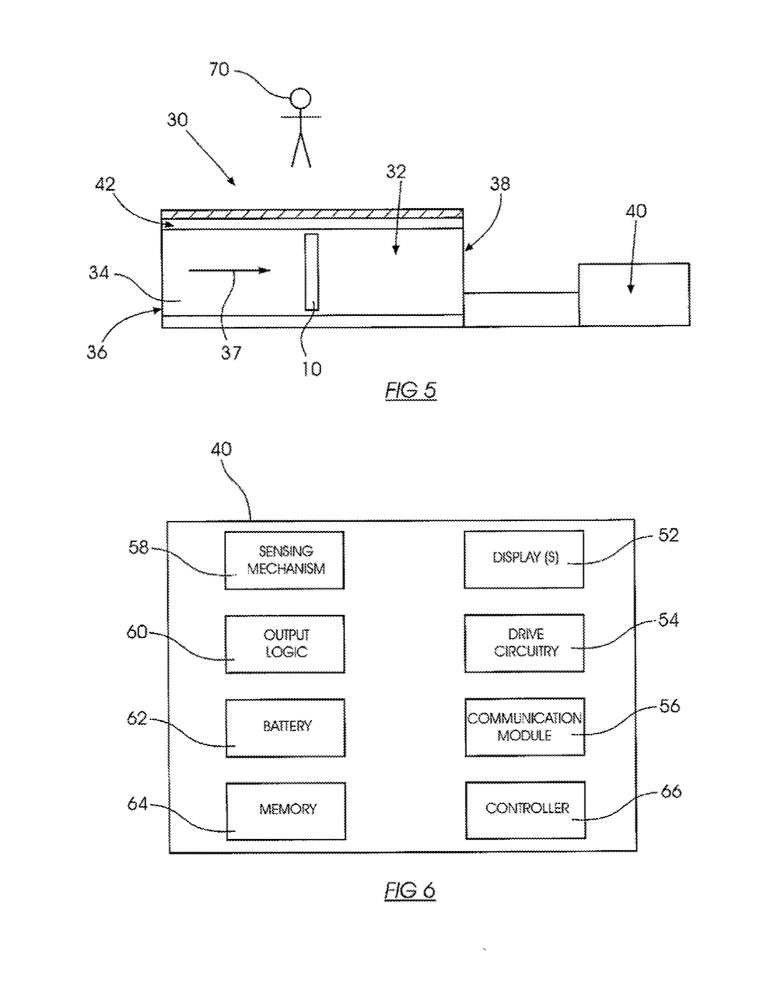

It is to be appreciated that the counter separator 10 may have other shapes in accordance with different embodiments as long as the counter separator includes a body to house or support electronic components to be described and as long as the body includes at least one side that can bear or support an electronic display. For example, FIG. 3 shows a portion of an embodiment 20 of a counter separator which includes a body 22 that has a longitudinal axis 24. The body 22 has rectangular cross section as can be seen from FIG. 4 which shows a cross section through the body 22 taken at 4-4 in FIG. 3. The sides 26 and 28 may each be provided with an electronic display.

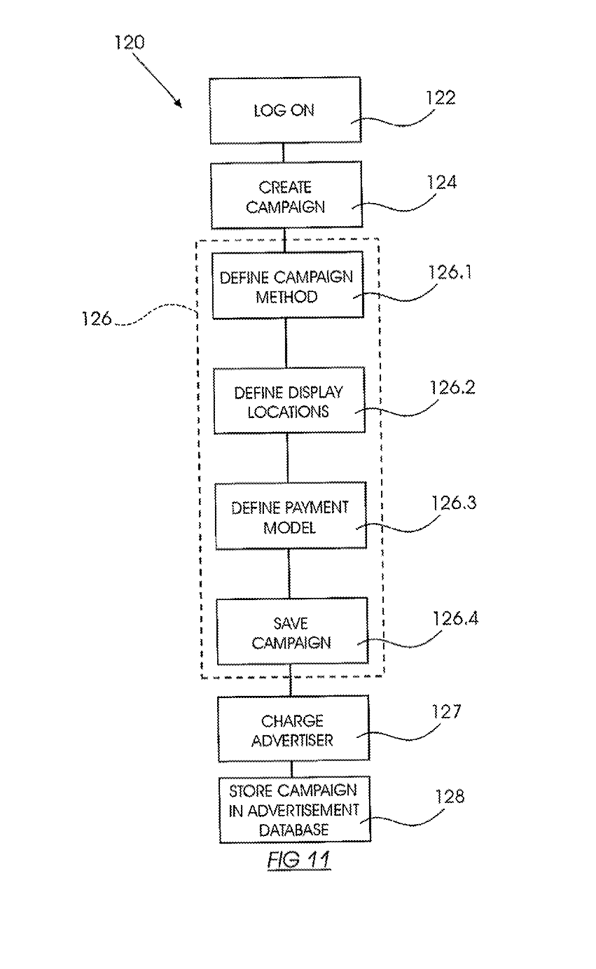

The counter separators of the present invention may be used to separate items to be purchased by different customers at a checkout counter of a store. FIG. 5 of the drawings shows a plan view of a representative checkout counter 30 at which the counter separators of the present invention may be deployed. As will be seen, the checkout counter 30 includes a counter top 32. The counter top 32 includes a conveyor belt 34 that defines a loading area having a first end 36 and a second end 38. In general, a customer will place items to be purchased onto the loading area proximate the first end 36. Behind the customer's items a counter separator 10 will be placed to distinguish the present customer's goods from the next customer's goods. Thereafter a cashier operates a switch to cause the conveyor belt 34 to move towards the second end 36 in the direction of arrow 37 thus moving the items towards the second end 38 where they may be removed by the cashier and rung up. Once the items have been rung up, they are bagged in a bagging area 40. In accordance with one embodiment, there is provided a charging rail 42 adjacent the conveyor belt 34. The charging rail 42 is shown in greater detail in FIG. 8 of the drawings and serves to charge the counter separators, as will be described later.

Referring now to FIG. 6 of the drawings, there is shown a block diagram of electronics 40 that form part of the counter separators 10, 20, in accordance with one embodiment of the invention. In one embodiment, the electronics 40 is housed within the body of the counter separator. As will be seen, the electronics includes at least one electronic display 52 (referenced as reference numeral 18 in FIG. 1). The electronic display 52 may be in accordance with a number of different display technologies. For example, in one embodiment, the electronic display 52 may comprise a light emitting diode (LED) array that can display advertisement information. In another embodiment the electronic display 52 may utilize a plurality of organic LEDs (OLEDS). In another embodiment, the electronic display 52 may comprise an LCD panel that can be driven to display information. In yet another embodiment, the electronic display 52 may comprise a number of interferometric modulators (imods) that can be operated to modulate incident light in order to display information.

In order to drive the electronic displays 52, the electronics 40 includes drive circuitry 54 which implements a driving scheme by which the electronic displays 52 are driven in order to display information thereon. A communications module/data interface 56 enables the counter separators 10, 20 to communicate with other devices as will be explained in greater detail below. In one embodiment, the communications module 56 may include a receiver to enable receipt of information to be displayed on the electronic displays 52. The communications module 56 may also include a transmitter to enable the counter separator to transmit information to other devices. In one example, the receiver and transmitter may be in the form of a mobile telephone network interface.

The electronics 40 may include a sensing mechanism 58 made up of switches and/or sensors to sense the orientation of the checkout counter separator 10, 20 on the checkout counter. In one embodiment, the orientation of the counter sensor is used by the drive circuitry 54 to drive the electronic displays 52 to ensure that information on the displays is always correctly oriented in relation to the intended viewer as will be described in greater detail below.

In one embodiment, the electronics 30 may include output logic 60 which implements output functions to enable the counter separator to transmit data associated with information displayed on the electronic displays 52 to other devices. For example, in one embodiment, the counter separators may be equipped with a print button which, when activated by a user, causes print data to be transmitted via the transmitter of the communications module 56 to a printer. The print button may be realized by a push button or by a touch sensor. An example of print data includes a coupon relating to an advertisement displayed on the electronic display 52, and contact information of an advertiser. For example, the contact information may comprise a name, telephone number, email address, and business address for an advertiser such as a real estate sales agent. In another embodiment the data may be transmitted to a consumer device such as a pocket digital assistant (PDA) or mobile telephone of a user. To enable this embodiment, the communications module 58 may include an infrared (IR) transmitter, a bluetooth interface, or a Wifi interface. In one embodiment, an output device such as a printer may be embedded in the counter separator.

In one embodiment, power for the operation of the electronics 30 is supplied by a rechargeable battery 62. The rechargeable battery 62 is recharged via a charging circuit that makes use of external contacts that are connectable to matched contacts of an external power source such as a charging apparatus. In another embodiment: the charging circuit may be inductively coupled with coils of the charging apparatus thereby to charge the battery 62. In one embodiment, the counter separator may include a photo-voltaic (PV) device to power the electronics 30.

The electronics 30 includes a memory 64 to store advertisement content to be displayed. A controller 66 controls operation of the components 52, 54, 56, 58, 60, 62, 64 of the electronics 30. In one embodiment, the controller includes a real-time-clock which can schedule display of the advertisement content stored in memory 64 in real time.

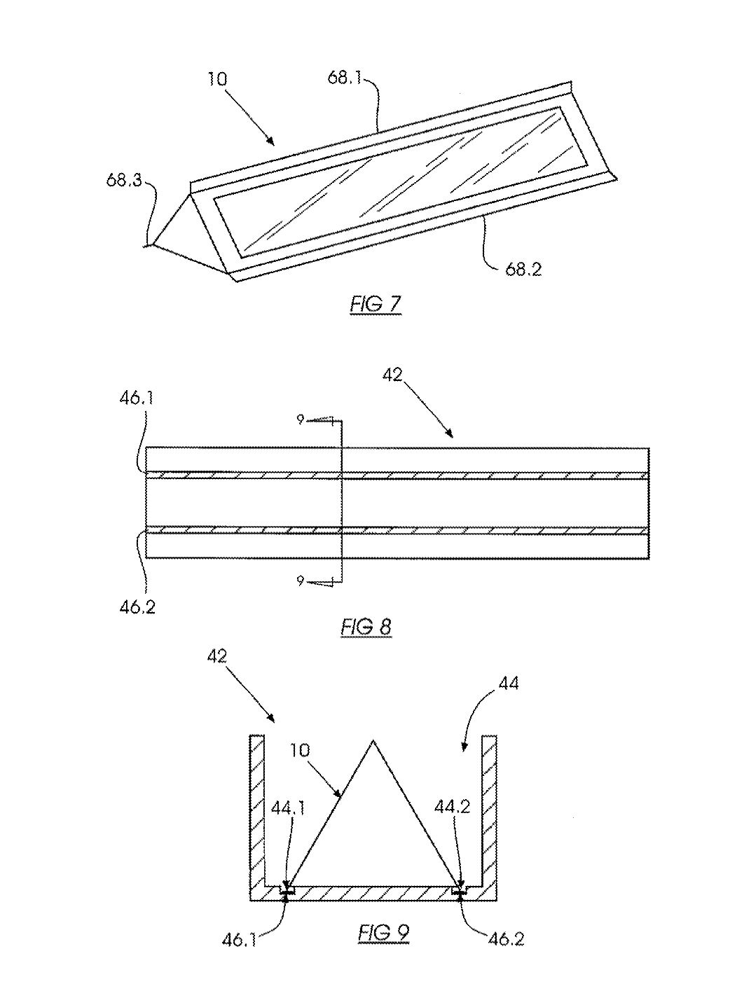

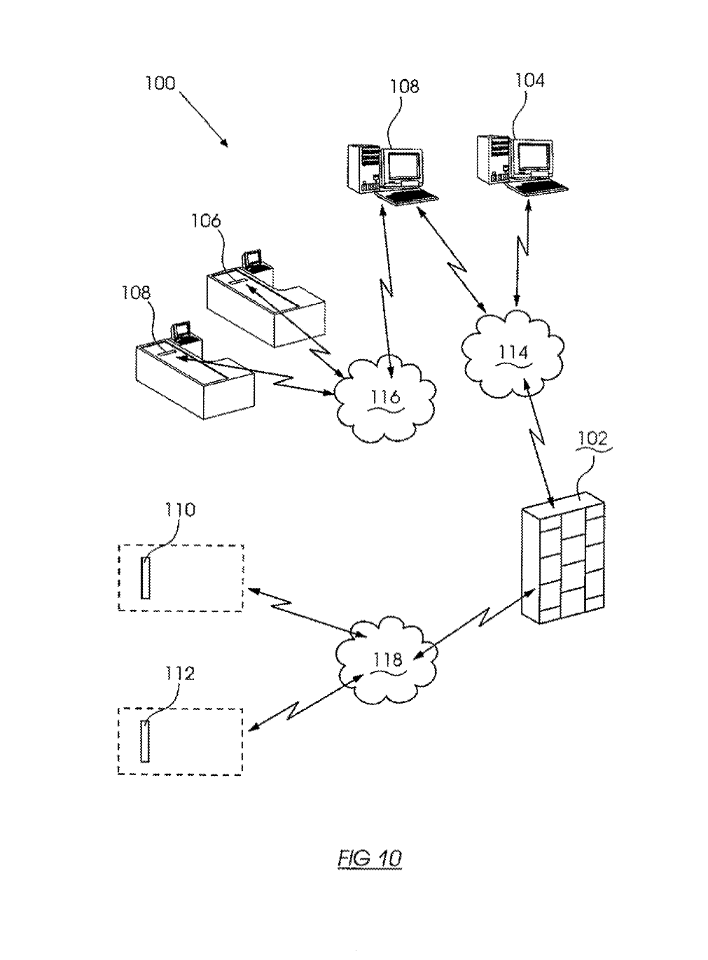

FIG. 7 of the drawings shows an embodiment of the counter separator 10 with external contacts in the form of charging panels 68.1, 68.2, 68.3 that can be energized to charge the battery 62. For charging the embodiment of FIG. 7, the charging rail 42 of FIGS. 8 and 9 is used. In FIG. 8 the charging rail 42 is shown in plan view, whereas FIG. 9 shows a cross section through the charging rail 42 taken at 9-9 in FIG. 8. As will be seen, the charging rail 42 defines a longitudinally extending channel 44 that is generally U-shaped in cross section. Two strip contacts 46.1, 46.2 are located within slots 44.1, 44.2 in the bottom of the channel 44 and are connected to an external power supply. One of the strip contacts 46.1/46.2 defines a positive contact whereas the other contact 46.2/46.1 defines a negative contact. In order to charge the embodiment of the counter separator shown in FIG. 7, the counter separator 10 is placed in the channel 44 so that any two of the external contacts 68.1, 68.2, 68.3 make physical contact with the strip contacts 46.1, 46.2.

In one embodiment, one of the external contacts 68 defines a positive contact having a first profile while the other defines a negative contact having a second profile that is different from the first profile. For this embodiment the recess within which the positive strip contact is located has a profile that is complementary to the first profile, and the recess within which the negative strip is located has a profile that is complementary to the second profile. This embodiment ensures that the counter separator has a correct orientation when placed in the rail 42 for charging, the correct orientation being that in which the positive contact of the separator is aligned with the positive strip of the charging rail 42 and in which the negative contact of the separator is aligned with the negative strip of the charging rail 42. Advantageously, by having complementary profiles as described, a user is given immediate tactile and/or visual feedback when the counter separator in incorrectly orientated in the charging rail 42.

In another embodiment, the strip contacts carry an alternating current and circuitry in the counter separator has a voltage rectifier to provide the correct direct current charging voltage to the battery 62.

For the embodiment of the counter separator that can be inductively charged, the separator does not have external contacts. Instead the separator has an internal inductive charging circuit that can be energized by the placement of the separator in the charging rail 42. For this embodiment, the exposed strip contacts 46.1, 46.2 of the charging rail 42 may be replaced with internal inductor coils mounted within a body of the channel 44 and coupled to a power supply.

The information that is displayed on the electronic displays 18.1, 18.2, 18.3 comprises advertisements. The advertisements may relate to products sold at the store in which the counter separators of the present invention are deployed. Equally, the advertisements may relate to goods and services that are not sold at the store. For example the advertisement may be that of a local real estate sales agent for a property listed in the neighborhood of the store. The advertisements are intended to be viewed by a customer 70 (see FIG. 5) standing adjacent the checkout counter 30. In order to be able to display the advertisements correctly to the customer 70 it is important to determine the orientation of the counter separator relative to an upper support surface of the checkout counter 30. Thus, for example, in the case of the counter separator 10 of FIG. 1, in one embodiment, the sensing mechanism 58 detects which of the sides 16 defines the base by which the separator 10 rests on the conveyor belt 34. The sensing mechanism 58 may include pressure sensors, for example, in order to detect the side 16 that defines the base. Equally, an arrangement of mercury switches may be used to determine which side forms the base. Referencing ends of the counter separator as A and B in FIG. 1, the sensing mechanism also detects which of the ends of A and B is located adjacent the charging rail 42. Detecting which end is adjacent the charging rail 42 may be achieved, in one embodiment by emitting a light beam to detect the charging rail 42, or by detecting a magnetic strip affixed to the charging rail 42 in another embodiment. Based on the detection of which end is located adjacent the charging rail 42, the driving mechanism is able to determine an operatively upper end for each of the electronic displays 18 on the sides 16. Once the operatively upper ends is known, the drive circuitry 54 causes information to be displayed on the electronic displays 18 based on the operatively upper ends so that the information is the right side up, from the point of view of the customer 70.

In another embodiment, the counter separators of the present invention may have a self orientating mechanism to orientated it so that it will tend to come to rest on the conveyor belt 34 on its base. The self-orientating mechanism may comprise a weight mounted inside the body of the counter separator to provide ballast to the body so that is comes to rest on its base. For this embodiment since the separator tends to rest on its base, there may be no need to detect which side defines the base.

In one embodiment, to protect the electronics 30, the counter separator may include a shock absorption mechanism to protect the electronics 30 from physical shock. In FIG. 1, two external shock absorption bands 17.1, 17.2 are positioned at the ends A, B respectively of the counter separator. In another embodiment, an internal shock absorption mechanism may be mounted inside the body 12 onto which the electronics 40 is mounted.

As noted above, the counter separators of the present invention may be used to display information in the form of advertisements to customers. The counter separators 10, 20 have a mechanism to load advertisements into the memory 64 of the counter separators 10, 20. In one embodiment the communications module 58 may include a USB port whereby the separator may be coupled to a computer so that information to be displayed by the separator may be downloaded into the memory 64. In another embodiment, the information may be downloaded to the counter separator using a WiFi or Bluetooth connection with the computer Referring now to FIG. 10 of the drawings, there is shown a method 100 of delivering advertisement content to a plurality of checkout counter separators, in accordance with one embodiment of the invention. The method 100 uses an embodiment of an advertisement delivery system 102 which delivers advertisement to multiple checkout counter separators (of which only four are shown as 106, 108, 110 and 112).

As illustrated in FIG. 17, the advertisement delivery system 102 includes a user authentication/log in module 102.1 an advertisement campaign database 102.2, a counter separator database 102.3, a network/web interface 102.4, an advertisement scheduler 102.5, a charging/billing system 102.6 and an advertisement transmission interface 102.7.

As will be seen, a plurality of advertisers (of which only one is shown as 104) are able to communicate with an advertisement delivery system 102 via a wide area network such as the Internet 114. In one embodiment, the advertisement delivery system 102 may be implemented as a web service on a server. The advertisement delivery system 102 may provide an interface whereby an advertiser 104 is able load advertisement content defining an advertisement campaign to display advertisements on the counter separators 106, 108, 110 and 112. In one embodiment the advertisement delivery system 102 transmits or sends the scheduled advertisements to a local advertisement scheduler 108 located at a store via, for example, a wide area network such as the Internet 114.

In the store, the local advertisement scheduler 108 distributes the advertisement content to the checkout counter separators 106, 108 via a local area network (LAN) such as a WiFi radio frequency network 116.

In another embodiment, the advertisement delivery system 102 transmits or sends the scheduled advertisements directly to each checkout counter scheduler 110, 112 individually via a mobile telephone network 118.

Referring to FIG. 11 of the drawings there is shown a flow diagram of a method 120 of defining an advertisement campaign on the advertisement delivery system 102. In the embodiment described the advertisement delivery system comprises a Web server to which an advertiser has access.

At 122 an advertiser logs onto the system 102. During initial registration an advertiser defines a preferred method of payment and provides the relevant payment details. The payment details are stored on a charging/billing system of the system 102. At 124 the advertiser creates a campaign by loading advertisement content onto the system 102. The advertisement content is restricted by the display capabilities of checkout counter separators on which the content is to be displayed. In one embodiment, An on-line template may be provided that defines the display area for which the content is to be loaded. When the advertiser is satisfied with the advertisement content that was defined, the content is saved on the system, e.g. under the username of the advertiser and under a unique advertisement campaign name.

At 126, the advertiser defines the advertisement campaign parameters according to which the advertisement is to be displayed. One of the campaign parameters includes a campaign method which is set at 126.1. In one embodiment, the campaign methods available include displaying the advertisement content at regular pre-defined intervals; and displaying the advertisement content during particular time slots displaying the advertisement content for a pre-defined number of times.

In one embodiment, the advertiser may select the display locations i.e. the stores where the advertisement content is to be displayed at 126.2. A menu is provided on the advertisement web server of all available locations where checkout counter separators are located. The advertiser defines the locations at 126.2 by selecting them from the menu.

The advertiser may select the payment model at 126.3. The payment model is linked to the campaign method selected at 126.1. If the advertiser chose to have the advertisement content displayed for a predefined number of times, the advertiser pays for displaying the advertising the predefined number of times. If the advertiser chose to have the advertisement content displayed in particular time slots the price of displaying the advertisement content is based on the timeslots selected. If the advertiser chose to have the advertisement content displayed at pre-defined intervals, the duration for which the advertisement content is displayed as well as the intervals between the displaying of the content is used to determine the price. In one embodiment all of the above payment models in combination with the number and type of retail outlets at which the advertisement content is displayed may be used to determine the final price of the advertisement campaign.

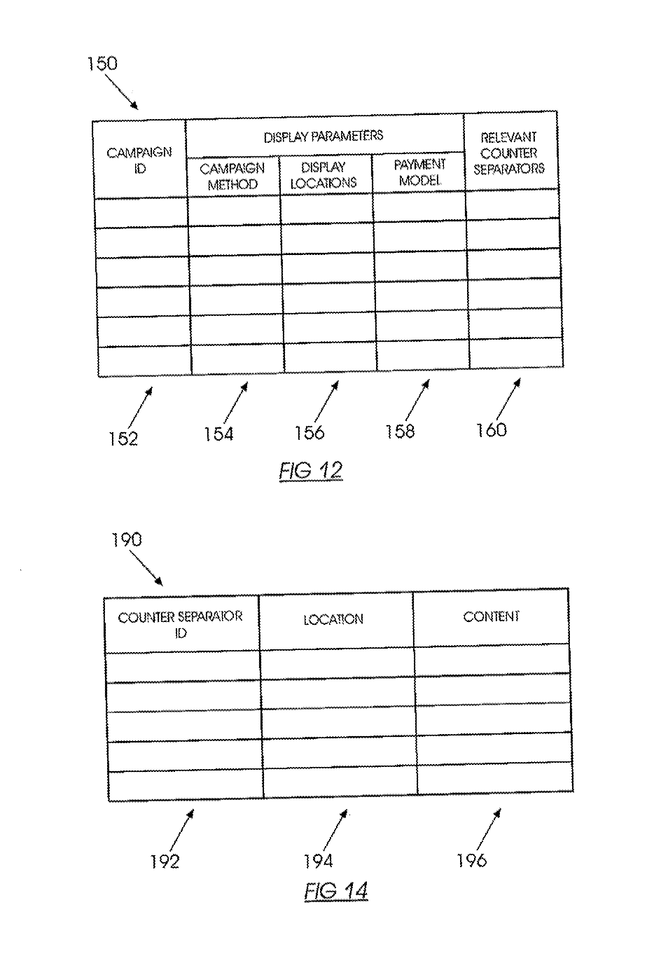

In one embodiment, the advertisement web server provides an interactive web page which provides feedback to the advertiser on the price of the campaign as certain options are selected. Once the payment model has been finalized the advertiser saves the advertisement campaign at 126.4. The advertiser is charged for the advertisement campaign at 127 by the charging system of the system 102. At 128, the advertisement campaign is stored in an advertisement campaign database 150 (FIG. 12) with previously stored advertisement campaigns.

In FIG. 12, one embodiment of a database is shown with a campaign ID defined in the first column 152, a campaign method defined in the second column 154, display locations in the third column 156′ a payment model. In the fourth column 158, and target counter separators (i.e. the ones that have been scheduled to receive advertisement content in accordance with the techniques disclosed later) shown in the fifth column 160.

In FIG. 13 of the drawings a flow diagram of a method 170 of scheduling advertisement content is shown.

At 172 the advertisement system 102 accesses the database 150 of all previously stored advertisement campaigns. At 174 the campaign parameters 154, 156, 158 are retrieved to perform the advertisement scheduling. At 176, the advertisement system 102 identifies the target counter separators on which the advertisement content for the newly defined advertisement campaign are to be displayed. The database 150, column 160 is populated with the relevant counter separators on which the new advertisement content of the newly defined advertisement campaign are to be displayed.

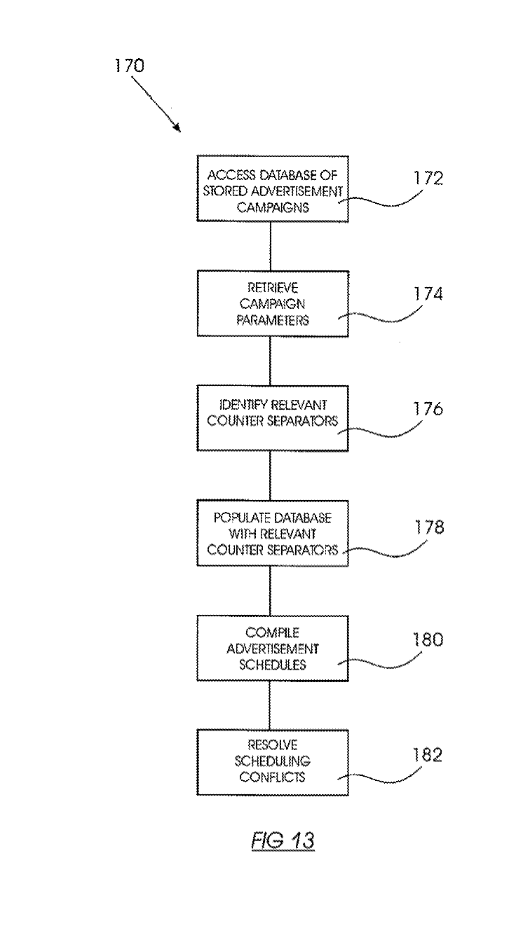

In one embodiment the advertisement system 102 maintains a database of counter separators in which is defined their unique ID's, their locations and the content to be displayed on each counter separator. An example of the database of counter separators is shown as 190 in FIG. 14. The counter separator's ID's are listed in 192 their locations in 194 and their advertisement content in 196.

Returning to FIG. 13, column 160 of the database 150 is populated with reference to the data stored in the database of counter separators 190. At 180 an advertisement schedule for each of the counter separators is compiled. Depending on the information of the campaigns in the database 150, there may be scheduling conflicts that needs to be resolved. At 182, such scheduling conflicts are resolved by modifying the advertisement schedule to accommodate all the advertisement campaigns.

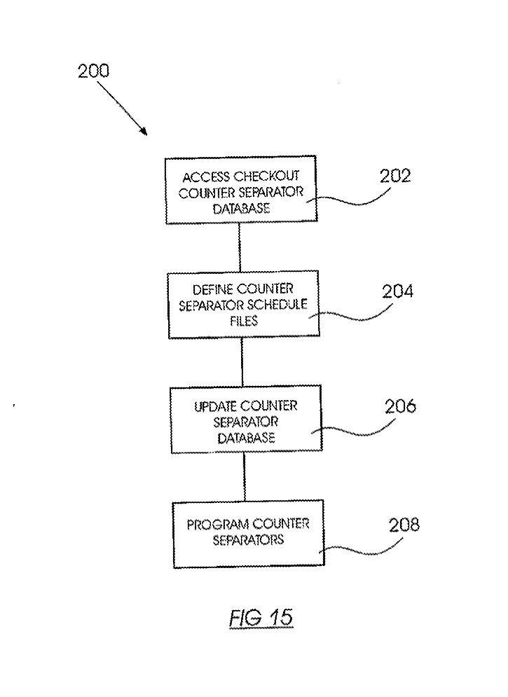

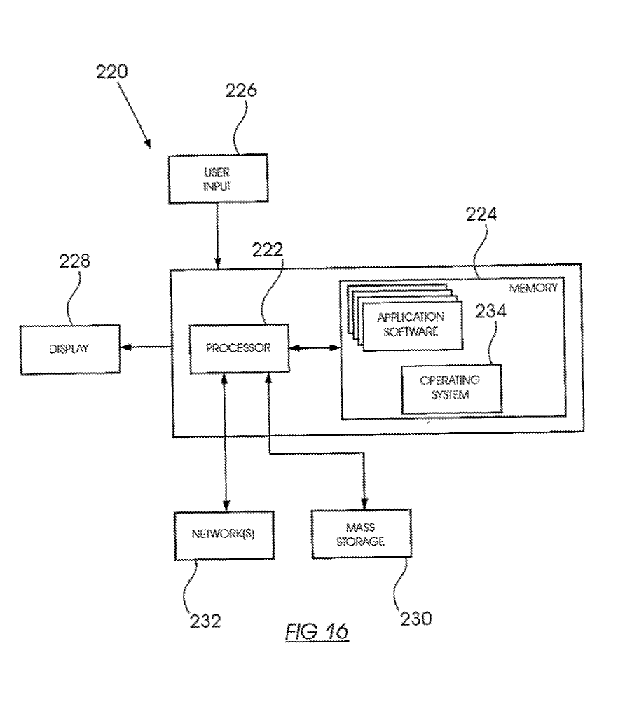

FIG. 15 shows a flow diagram of a method 200 of distributing advertisement content to at least one checkout counter separator. At 202 the counter separator database 190 is accessed. At 204; the advertisement content for each counter separator is stored in a counter separator schedule file. At 206, the advertisement content is stored in the database 190 in 196. When the whole database 190 has been updated, at 208, all the counter separators are reprogrammed.

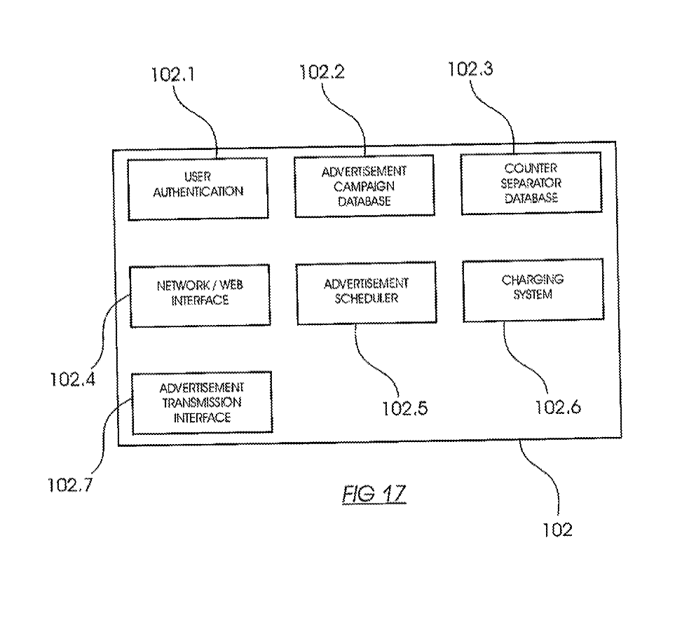

FIG. 16 of the drawings shows an example of hardware 220 that may be used to realize the advertisement system 102 in accordance with one embodiment of the invention. The hardware 220 typically includes at least one processor 222 coupled to a memory 224. The processor 222 may represent one or more processors (e.g., microprocessors), and the memory 224 may represent random access memory (RAM) devices comprising a main storage of the hardware 220, as well as any supplemental levels of memory e.g., cache memories, non-volatile or back-up memories (e.g. programmable or flash memories), read-only memories, etc. In addition, the memory 224 may be considered to include memory storage physically located elsewhere in the hardware 220, e.g. any cache memory in the processor 222 as well as any storage capacity used as a virtual memory, e.g., as stored on a mass storage device 230.

The hardware 220 also typically receives a number of inputs and outputs for communicating information externally. As interface to a user or operator, the hardware 220 may include one or more user input devices 226 (e.g., a keyboard, a mouse, etc.) and a display 228 (e.g., a Liquid Crystal Display (LCD) panel). For additional storage, the hardware 220 may also include one or more mass storage devices 230, e.g., a floppy or other removable disk drive, a hard disk drive, a Direct Access Storage Device (DASD), an optical drive (e.g. a Compact Disk (CD) drive, a Digital Versatile Disk (DVD) drive, etc.) and/or a tape drive, among others. Furthermore, the hardware 220 may include an interface with one or more networks 232 (e.g., a local area network (LAN), a wide area network (WAN), a wireless network, and/or the Internet among others) to permit the communication of information with other computers coupled to the networks. It should be appreciated that the hardware 220 may include suitable analog and/or digital interfaces between the processor 222 and each of the components 224, 226, 228, and 232 as is well known in the art.

The hardware 220 operates under the control of an operating system 234, and executes various computer software applications, components, programs, objects, modules, etc. to facilitate the creation of advertisements, the charging of advertisers and the transmission of advertisements to the counter separators. Moreover, various applications, components, programs, objects, etc. may also execute on one or more processors in another computer coupled to the hardware 220 via a network 232, e.g. in a distributed computing environment, whereby the processing required to implement the functions of a computer program may be allocated to multiple computers over a network.

In general, the routines executed to implement the embodiments of the invention may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

While certain exemplary embodiments have been described and shown in the accompanying drawings, it is to be understood that such embodiments are merely illustrative and not restrictive of the broad invention and that this invention is not limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principals of the present disclosure.

What is claimed is:

1. A method, comprising,
receiving input defining an advertisement campaign from at least one advertiser, the advertisement campaign specifying advertisement content to be delivered to at least one checkout counter separator at a point of sale; and
delivering the advertisement content to the at least one checkout counter separator for display on a display thereof.

2. The method of claim 1, wherein the advertisement content is delivered over a wireless network.

3. The method of claim 1, further comprising scheduling the advertisement content prior to delivering it to the at least one checkout counter separator.

4. The method of claim 3, the scheduling comprises resolving schedule conflicts prior to delivering the advertisement content to the at least one checkout counter separator.

5. The method of claim 3, further comprising receiving payment for the scheduled advertisement content from the at least one advertiser.

6. The method of claim 1, wherein the delivering comprises delivering the advertisement content to a plurality of checkout counters in parallel.

7. A checkout counter separator comprising;
an elongate body defining a longitudinal axis and at least two longitudinal sides;
a data interface to receive advertisement content from an advertisement delivery system; and
at least one electronic advertisement display panel defining a display face on at least one of the longitudinal sides, the display to display the advertisement content.

8. The checkout counter separator of claim 7, in which the data interface is a wireless data interface.

9. The checkout counter separator of claim 8, in which the wireless data interface is in the form of a mobile telephone network interface.

10. The checkout counter separator of claim 7, further comprising an orientation sensor to detect the orientation of the elongate body on a support surface and to display the advertisement content in an upright orientation on the display.

11. The checkout counter separator of claim 7, further comprising a shock absorption arrangement.

12. The checkout counter separator of claim 7, further comprising an internal rechargeable power source.

13. The checkout counter separator of claim 12 further comprising a recharging arrangement connectable to an external power source for recharging the rechargeable power source.

14. An advertisement delivery system, comprising:
a database to store advertisement content of at least one advertiser; and
a data interface to deliver the advertisement content of the at least one advertiser to at least one checkout counter separator.

15. The advertisement delivery system of claim 14, further comprising a scheduler to schedule the advertisement content of the at least one advertiser to be displayed according to a time schedule on the at least one counter separator.

16. The advertisement delivery system of claim 14, in which the data interface is in the form of a mobile telephone network interface to deliver the advertisement content over a mobile telephone network to the at least one checkout counter separator.

17. The advertisement delivery system of claim 14, further comprising a network interface to permit an advertiser to store advertisement content on the database.

18. The advertisement delivery system of claim 14, which further comprising a charging system to charge an advertiser for advertisement content to be displayed on the at least one checkout counter separator.
